(19) United States
(12) Patent Application Publication
(10) Pub. No.: US 2024/0213560 A1
(43) Pub. Date: Jun. 27, 2024

(54) METHOD FOR RECYCLING AN ELECTRODE

(71) Applicants: COMMISSARIAT A L'ENERGIE ATOMIQUE ET AUX ENERGIES ALTERNATIVES M, Paris (FR); ORANO, Chatillon (FR)

(72) Inventor: Emmanuel Billy, Grenoble (FR)

(21) Appl. No.: 17/907,114

(22) PCT Filed: Mar. 26, 2021
(86) PCT No.: PCT/FR2021/050537

§ 371 Date: Sep. 23, 2022

(30) Foreign Application Priority Data
Apr. 1, 2020 (FR) 2003254

(51) Int. Cl. H01M 10/54; C01G 53/00; C22B 3/22; C22B 7/00; C22B 21/00

(52) U.S. Cl. CPC H01M 10/54; C01G 53/50; C22B 3/22; C22B 7/008; C22B 21/0023; C01P 2002/72; C01P 2004/03; C01P 2006/40

(57) ABSTRACT

A method for recycling at least one electrode comprising the following successive steps: a) providing at least one electrode comprising a current collector, an active material and, optionally, a binder, b) immersing the at least one electrode in an ionic liquid solution, comprising a solvent ionic liquid, in the presence of ultrasounds, whereby the active material, and optionally the binder, is separated from the current collector.

### TECHNICAL FIELD

The present invention relates to the general field of recycling of, for example lithium, accumulators or batteries, and more particularly, to the recycling of Li-ion type batteries.

The invention relates to a recycling method for recycling positive electrodes or negative electrodes.

The invention is particularly interesting since it allows the active material and the current collector to be reclaimed at the same time.

### State of Prior Art

The market for lithium accumulators (or batteries), in particular of the Li-ion type, is now growing rapidly, especially with the development of mobile applications (“smartphone”, portable electric tools, etc.) and with the emergence of electric and hybrid vehicles.

Lithium-ion accumulators comprise an anode, a cathode, a separator, an electrolyte and a casing, which may be a polymer pouch or a metal packaging. The negative electrode typically comprises graphite, mixed with a binder such as carboxymethylcellulose (CMC) or polyvinylidene fluoride (PVDF), and deposited on a copper foil acting as a current collector. The positive electrode is a lithium-ion insertion material (for example, LiCoO₂, LiMnO₂, Li₃NiMnCoO₆, LiFePO₄), mixed with a polyvinylidene fluoride type binder, and deposited on an aluminium foil acting as a current collector. The electrolyte consists of lithium salts (LiPF₆, LiBF₄, LiCF₃SO₃, LiClO₄) solubilised in an organic base consisting of mixtures of binary or ternary solvents based on cyclic carbonates (ethylene carbonate, propylene carbonate, butylene carbonate), linear or branched carbonates (dimethyl carbonate, diethyl carbonate, ethyl methyl carbonate, dimethoxyethane) in various proportions.

The operation is as follows: during charging, the lithium deintercalates from the active material of the positive electrode and is inserted into the active material of the negative electrode. During discharge, the process is reversed.

Given the environmental, economic and strategic challenges of supplying certain metals present in batteries, it is necessary to recycle at least 50% of the materials contained in Li-ion batteries and accumulators (Directive 2006/66/EC).

In particular, it is necessary to recycle and reclaim elements from the current collectors (copper, aluminium) and the active material (carbon and metal oxides).

During the recycling method, the pre-treatment steps are fundamental because they determine the amount of “black mass” (mixture containing metals of the positive electrode) that can be subsequently treated by hydrometallurgical means. The aim is to obtain the most concentrated fraction of metals possible while limiting the amount of impurities to a minimum.

For this, it is essential to separate the insertion materials from the metal current collectors (typically aluminium and copper). This reduces contamination of the chemical bath used for the reclaiming of the insertion materials (cobalt, lithium or nickel) with metal elements from the current collectors, and also allows the current collectors to be recovered, thus the recycling rate to be increased.

The separation of the current collectors (Cu, Al) from the insertion materials (carbon, metal oxides) is generally achieved by thermal and/or mechanical means.

For example, thermal treatment at 500° C. degrades the binder of the electrode. Crushing and sieving steps can then be carried out to recover the higher value elements. However, the method generates toxic gases and consumes carbon with CO₂ formation.

A major drawback of mechanical separation itself is that it does not fully separate all the components of the batteries, as some compounds (metals, organic substances, inorganic substances) penetrate each other, generating a complex mixture whose different constituents are difficult to separate.

One of the most promising routes is the chemical route because it allows dissolution of current collectors in an aqueous medium and/or the dissolution of binders (CMC, PVDF, etc.). However, the dissolution of collectors in aqueous media requires large amounts of acids and/or concentrated acids. In addition, this leads to impurities in the hydrometallurgical method. The dissolution of binders requires organic solvents (N-Methyl-2-pyrrolidone (NMP), N—N dimethyl formamide (DMF), N-dimethyl acetamide (DMAC) or dimethyl sulfoxide (DMSO)), which presents risks and hazards for humans and the environment.

In order to remedy these drawbacks, research has turned to ionic liquids which are stable under atmospheric conditions (absence of reactions leading to the formation of hydrofluoric acid). They allow the selective separation of carbon and metal oxides from copper and aluminium collectors in batteries and accumulators.

For example, using an ionic liquid [BMIM][BF₄] heated to 180° C. with stirring at 300 rpm, it is possible to melt a PVDF binder and thus separate an aluminium collector from a cathode material. Under these treatment conditions, the separation efficiency of the aluminium collector from the LiCoO₂ active material is 99% for a 25 min treatment [1]. However, the treatment has several drawbacks: it has to be performed at a very high temperature of 180ºC and the use of a BF₄⁻ anion is detrimental for use in an ambient atmosphere as it degrades by hydrolysis with water, forming hydrofluoric acid.

The melting of the PVDF binder of a cathode was also carried out with a molten AlCl₃—NaCl salt heated to 160° C., with an active material/molten salt ratio of 10%. For these treatment conditions, the separation efficiency of the aluminium collector from the LiCoO₂ active material is 99.8% by mass after 20 min of treatment [2]. However, the treatment is performed at an equally high temperature of 160° C. In addition, the use of a water-sensitive AlCl₃ salt can lead to its hydrolysis and the dissolution of the collector.

It has also been shown that PVDF can be degraded using choline glycerol chloride (a deep eutectic solvent) as an ionic liquid, heated to 190° C. After 15 min, the separation efficiency of the aluminium collector from the Li(NiMnCo)_{1/3}O₂ active material is 99.86% [3]. However, the temperatures required to carry out the method are also very high.

### DISCLOSURE OF THE INVENTION

One purpose of the present invention is to provide a method for recycling an electrode by effectively separating the active material from the current collector, the method having to be capable of being carried out at reasonable temperatures (typically below 160° C.).

For this, the present invention provides a method for recycling at least one electrode comprising the following successive steps:
a) providing at least one electrode comprising a current collector, an active material and, optionally, a binder,
b) immersing the at least one electrode in an ionic liquid solution, comprising a solvent ionic liquid, in the presence of ultrasounds, whereby the active material, and optionally the binder, is separated from the current collector.

The invention differs fundamentally from prior art by the implementation of the separation step with an ionic liquid in the presence of ultrasounds. The ionic liquid medium makes it possible to detach and separate the various components of an electrode selectively, without dissolving the binder when it is present, without degrading the medium, while avoiding the release of gas. In the presence of ultrasounds, detaching/exfoliating the current collector insertion materials, by immersion in the ionic liquid solution, is carried out in a very short time (typically less than 1 h, or even less than or equal to 30 min) and for low temperatures (typically less than or equal to 150° C.) with yields greater than 99%.

The method provided allows the current collector and the active material of an electrode to be extracted and reclaimed separately.

According to a first alternative embodiment, the electrode is a positive electrode. By positive electrode (also called cathode), it is meant the electrode which is the site of an oxidation during charging and which is the site of a reduction during discharge.

According to a second alternative embodiment, the electrode is a negative electrode. By negative electrode (also called anode), it is meant the electrode which is the site of a reduction during charging and which is the site of an oxidation during discharge.

Advantageously, the solvent ionic liquid comprises a cation selected from one of the following families: imidazolium, pyrrolidinium, ammonium, piperidinium and phosphonium.

Advantageously, the solvent ionic liquid comprises an anion selected from the halides or bis(trifluoromethanesulphonyl)imide (CF₃SO₂)₂N— denoted as TFSI⁻, bis(fluorosulphonyl)imide (FSO₂)₂N⁻ denoted as FSI⁻, trifluoromethanesulphonate or triflate denoted as CF₃SO₃⁻, tris(pentafluoroethyl)trifluorophosphate denoted as FAP⁻ and bis(oxalato)borate denoted as BOB, anions.

Even more advantageously, the anion is a chloride, in combination with an ammonium or phosphonium cation. The ionic liquid solvent is preferably [P66614][CI].

Advantageously, the ionic liquid solution forms a deep eutectic solvent.

Advantageously, the deep eutectic solvent is a mixture of choline chloride and ethylene glycol.

Advantageously, step b) is carried out at a temperature ranging from 20° ° C. to 150° C., and preferably from 30° C. to 120° C.

Advantageously, step b) is carried out for a duration ranging from 2 min to 1 h, and preferably from 3 min to 30 min.

Advantageously, the power of the ultrasounds ranges from 0.5 to 16 kW.

Advantageously, the frequency of the ultrasounds is between 16 KHz and 500 KHz and preferably between 16 KHz and 50 KHz.

Advantageously, the ionic liquid solution contains one or more additional ionic liquids.

Advantageously, in step a), a plurality of electrodes is provided, said electrodes being identical or of different natures.

The method has many advantages:
economic and environmental gain by separating the current collectors and active material by a simple detachment,
low implementation temperature,
selective separation of the different elements without dissolving the current collectors and/or the binder, which avoids contamination,
selective separation without degrading the medium,
the method avoids gas evolution, which makes it safer,
the method is simple and quick to implement,
the method avoids the consumption of reagent and the reprocessing of solutions (effluents),
the method can be operated in a closed circuit.

Further characteristics and advantages of the invention will become apparent from the following further description.

It goes without saying that this further description is given only by way of illustration of the object of the invention and should in no way be construed as a limitation of that object.

### BRIEF DESCRIPTION OF THE DRAWINGS

The present invention will be better understood upon reading the description of examples of embodiments given purely by way of illustrating and in no way limiting purposes, with reference to the appended drawings in which:

FIG. 1 is a picture representing positive current collectors, and active material in particulate form obtained after the implementation of a method of prior art. FIGS. 2a and 2b are images obtained by scanning electron microscopy of active material, in particulate form, obtained after the implementation of a method of prior art.

FIG. 2c is a picture obtained by X-ray diffraction of the active material after the implementation of a method of prior art,

FIG. 3 is a picture representing positive current collectors and active material in particulate form obtained after the implementation of a particular embodiment of the method according to the invention.

FIGS. 4a and 4b are images obtained by scanning electron microscopy of active material, in particulate form, and of a positive current collector, obtained after the implementation of a method of prior art.

FIG. 5 is a picture representing negative current collectors, and active material in particulate form obtained after the implementation of a particular embodiment of the method according to the invention.

FIG. 6 is a picture representing negative current collectors and active material in particulate form obtained after the implementation of a particular embodiment of the method according to the invention.

FIG. 7 is a picture representing positive current collectors and active material in particulate form obtained after the implementation of a particular embodiment of the method according to the invention.

### DETAILED DESCRIPTION OF PARTICULAR EMBODIMENTS

Although by no means limiting, the invention has particular applications in the field of recycling and/or reclaiming of electrodes of Li-ion type batteries/accumulators/cells.

The recycling method comprises the following successive steps:
a) providing an electrode comprising a current collector covered by an active material and, optionally, a binder,
b) immersing the electrode in an ionic liquid solution, comprising a solvent ionic liquid, in the presence of ultrasounds, whereby the active material, and optionally the binder, is separated from the current collector.

The electrode may be, for example, from a battery or accumulator.

The active material is an active insertion material (also called active material). By binder, it is meant a polymeric binder. The active material and the binder are preferably mixed.

The electrode can be a negative electrode (anode). The active material of the negative electrode is, for example, carbon-based, for example, graphite. It may also be lithium titanate Li₄Ti₅O₁₂ (LTO). The active material may be mixed with a PVDF-type binder. The current collector can be a copper foil.

The electrode can be a positive electrode (cathode). The active material is a lithium-ion insertion material. It can be a lamellar oxide of the LiMO₂ type, a LiMPO₄ phosphate of olivine structure or a LiMn₂O₄ spinel compound. M represents a transition metal. For example, LiCoO₂, LiMnO₂, LiNiO₂, Li₃NiMnCoO₆, or LiFePO₄ are selected. The insertion material can be mixed with a polyvinylidene fluoride type binder. It is deposited on a current collector, for example, an aluminium foil.

The largest dimension of the electrode is, for example, between 0.05 cm and 15 cm, and preferably between 0.5 and 5 cm.

In step b), the electrode is immersed in the ionic liquid solution.

Several identical electrodes or different natures may be immersed, consecutively or simultaneously, in the ionic liquid solution.

The electrode is at least partially immersed and preferably fully immersed in the ionic liquid solution.

The electrode may be attached to another element or float in the ionic liquid solution.

The ionic liquid solution enables the active material in particle form to be separated from the current collector and these particles to be stabilised while avoiding their dissolution. It is also possible to separate the active material in the form of a block of particles whose cohesion can be ensured by the binder.

By particles, it is meant elements with a spherical, elongated, or ovoid shape, for example. They may have a largest dimension of less than 200 μm, for example ranging from 2 nm to 20 μm. In the case of spherical particles, this is the diameter. This size can be determined by dynamic light scattering (DLS).

The solution comprises one or more ionic liquids. By ionic liquid, it is meant the combination of at least one cation and at least one anion that generates a liquid with a melting temperature of less than or about 100° C. Ionic liquids are non-volatile and non-flammable solvents that are chemically stable at temperatures above 200° C.

The ionic liquid solution comprises at least one ionic liquid called solvent ionic liquid. By solvent ionic liquid, it is meant an ionic liquid that is thermally and chemically stable to minimise a degradation effect of the medium during the detaching phenomenon.

The ionic liquid solution may also comprise one or more (two, three for example) additional ionic liquids, that is, it comprises a mixture of several ionic liquids. The additional ionic liquid(s) (LI₂, LI₃, . . . ) have an advantageous role with respect to the detachment step and in particular with respect to one or more properties of: viscosity, solubility, hydrophobicity, melting temperature.

The cation of the solvent ionic liquid is preferably selected from one of the following families: imidazolium, pyrrolidinium, ammonium, piperidinium and phosphonium.

Preferably, it is a cation with low environmental impact and low cost. Advantageously, an ammonium or phosphonium cation is selected. Advantageously, the cation may be selected from the group consisting of a tetraalkylammonium, an N,N-dialkylimidazolium, an N,N-dialkylpyrrolidinium, a tetraalkylphosphonium, a trialkylsulfonium and an N,N-dialkylpiperidinium.

In particular, phosphonium cations are stable and facilitate the extraction of the active material in particulate form.

More advantageously, a cation with C₂-C₁₄ alkyl or fluoroalkyl chains is selected, typically the cation [P66614]+(trihexyltetradecylphosphonium).

The cation of the solvent ionic liquid is associated with an anion which is either organic or inorganic, preferably having a low environmental impact and a low cost. Advantageously, anions are used which make it possible to obtain at least one, and preferably all, of the following properties:
a moderate viscosity,
a low melting temperature (liquid at room temperature),
not leading to hydrolysis (degradation) of the ionic liquid.

Preferably, the anion of the solvent ionic liquid has no or very little complexing affinity. The anion is, for example, selected from the halides, bis(trifluoromethanesulphonyl)imide (CF₃SO₂)₂N— denoted as TFSI⁻, bis(fluorosulphonyl)imide (FSO₂)₂N⁻ denoted as FSI⁻, trifluoromethanesulphonate or triflate CF₃SO₃⁻, tris(pentafluoroethyl)trifluorophosphate denoted as FAP⁻, and bis(oxalato)borate denoted as BOB, anions.

Preferably, the chloride anion is selected, for example, in combination with an ammonium or phosphonium cation. By way of illustration, the solvent ionic liquid trihexyltetradecylphosphonium chloride denoted as [P66614][CI] can be used.

Among the various combinations that can be contemplated, a medium with low cost and low environmental impact (biodegradability) is favoured.

A non-toxic medium with high biodegradability that can even be used as a food additive, can be selected.

For example, an ionic liquid forming a deep eutectic solvent (or “DES”) is selected. This is a liquid mixture at room temperature obtained by forming a eutectic mixture of 2 salts, of the general formula:

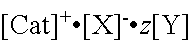

with:
Cat]⁺ is the cation of the ionic liquid solvent (for example ammonium),
[X]⁻ is a halide anion (for example Cl⁻),
[Y] is a Lewis or Brönsted acid which can be complexed with the anion X⁻ of the solvent ionic liquid, and z is the number of molecules Y.

For example, the DES is choline chloride in combination with an H-bond donor of very low toxicity, such as ethylene glycol, glycerol or urea, which ensures a non-toxic and very low-cost DES. According to another example, choline chloride can be replaced with betaine.

Optionally, the ionic liquid solution may comprise a desiccant, and/or a material transport promoting agent.

The anhydrous desiccant may be a salt that is not involved in the reactions at the electrodes and does not react with the solvent, for example MgSO₄, Na₂SO₄, CaCl₂), CaSO₄, K₂CO₃, NaOH, KOH or CaO.

The material transport promoting agent is, for example, a fraction of a co-solvent that can be added to reduce viscosity, such as 5% water. An organic solvent can also be introduced and, more advantageously, battery electrolyte residues can be used as a co-solvent (carbonate-based medium) to increase the recycling rate of the battery. Non-exhaustive examples are vinylene carbonate (VC), gamma-butyrolactone (γ-BL), propylene carbonate (PC), polyethylene glycol, dimethyl ether. The concentration of the material transport promoting agent advantageously ranges from 1% to 40% and more advantageously from 5% to 15% by mass.

During the method, the temperature of the mixture is preferably below 160° ° C., and even more preferably below 150° C. It ranges, for example, from 20° C. to 150° C., preferably from 30° ° C. to 150° C., even more preferably from 30° C. to 120° C.

Step b) may be carried out in air or in an inert atmosphere such as, for example, argon or nitrogen.

Stirring, for example between 50 rpm and 2000 rpm, can be carried out to ensure the feed of reagent. This speed will be adjusted according to the ionic liquid solution. Preferably, stirring ranges between 200 rpm and 800 rpm.

Step b) is carried out with ultrasounds. The activation by ultrasounds considerably reduces the temperature and/or the time required to completely detach the active material from the current collector.

Preferably, the frequency of the ultrasounds is between 16 KHz and 500 KHz and preferably between 16 KHz and 50 KHz.

Preferably, the power of the ultrasounds is between 0.5 and 16 kW.

The duration of step b) (detachment step) can be estimated according to the nature and dimensions of the crushed battery and accumulator material.

The electrode recycling method can be implemented in a method for recycling cells and/or accumulators and/or batteries. The recycling method may comprise the following steps: sorting, dismantling of the battery, physical (crushing, manual separation, . . . ) and/or chemical (washing of the electrolyte, . . . ) pre-treatment, implementation of the electrode recycling method previously described.

This recycling method may further comprise a subsequent step during which conventional techniques (pyrometallurgy and/or hydrometallurgy, . . . ) are used to recover and reclaim the various components, and mainly the active material (metal oxide).

### Illustrative and Non-Limiting Examples of an Embodiment

### Example 1: Detaching a Positive Electrode in Ionic Liquid Medium P66614 CI (Comparative Example)

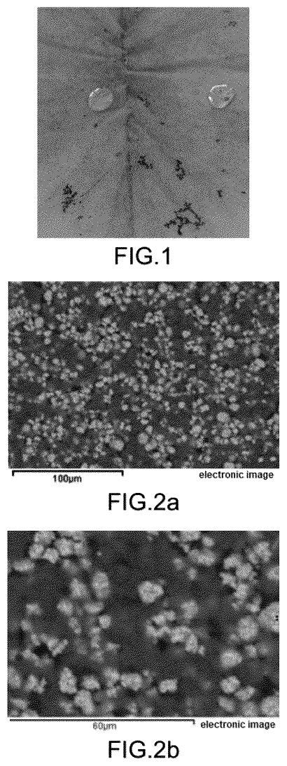

An 18650 Li-ion battery is first discharged, opened and then dried. The positive electrode, formed of an aluminium collector and Li(NiMnCo)_{1/3}O₂ type active material, is removed manually. The positive electrode, in the form of electrode pellets, is immersed in 50 mL an of ionic liquid solution [P66614][CI] (Trihexyltetradecylphosphonium chloride) at a temperature of 110° C. under stirring at 200 rpm. After 1 hour of treatment, the active material is completely detached. The aluminium is free of particles and without corrosion on the surface, while the active material (Li(NiMnCo)_{1/3}O₂)) is in the form of small intact particles (FIG. 1).

### Example 2: Detaching a Positive Electrode in an Ethaline Ionic Liquid Medium (Comparative Example)

An 18650 Li-ion battery is first discharged, opened and then dried. The positive electrode, formed of an aluminium collector and Li(NiMnCo)_{1/3}O₂ type active material, is removed manually. Electrode pellets are then immersed in 50 ml of an Ethaline ionic liquid solution (choline chloride: ethylene glycol mixture in a 1:2 ratio) at a temperature of 150° C. under stirring at 200 rpm.

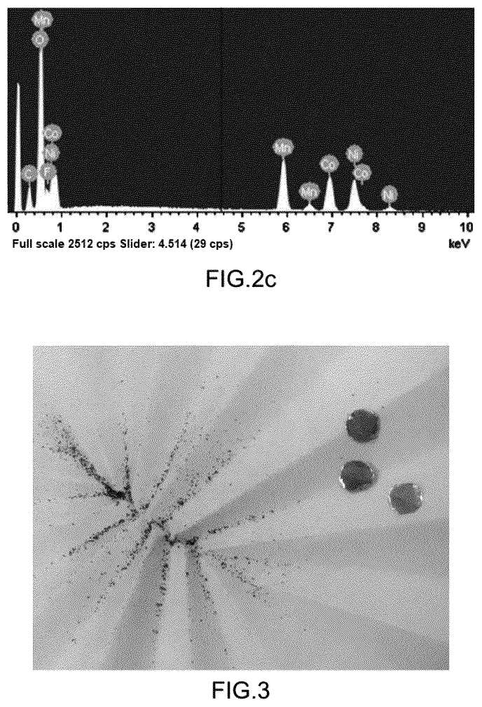

After 3.5 hours of treatment, the active material is completely detached. At the end of the method, the active material (Li(NiMnCo)_{1/3}O₂)) is in the form of small particles (FIGS. 2a, 2b) and the aluminium is free of particles and shows no signs of corrosion on its surface. X-ray diffraction analysis confirms that the particles have the same composition (cobalt, manganese and nickel) as initially (FIG. 2c).

### Example 3: Detaching a Positive Electrode in an Ethaline Ionic Liquid Medium with Ultrasound Activation According to the Invention

An 18650 Li-ion battery is first discharged, opened and then dried. The positive electrode, formed of an aluminium current collector and (Li(NiMnCo)_{1/3}O₂) type active material, is removed manually. Electrode pellets are immersed in 50 ml of an Ethaline ionic liquid solution (choline chloride:ethylene glycol mixture in a ratio of 1:2) at 150° C. under stirring at 200 rpm and in the presence of ultrasounds.

After only 20 minutes of treatment, the active material is completely detached. The aluminium is free of particles, shows no signs of corrosion on the surface and the active material (Li(NiMnCo)_{1/3}O₂)) is in the form of small intact particles (FIG. 3).

### Example 4: Detaching a Negative Electrode in an Ethaline Ionic Liquid Medium (Comparative Example)

An 18650 Li-ion battery is first discharged, opened and then dried. The negative electrode formed of a current collector made of copper and carbon as active material, is removed manually. Electrode pellets are immersed in 50 ml of an Ethaline ionic liquid solution (choline chloride:ethylene glycol mixture in a ratio of 1:2) at 150° C. under stirring at 200 rpm.

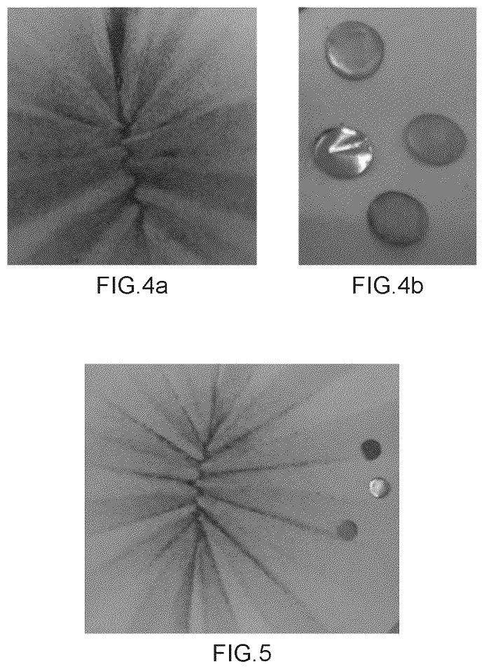

After 2 hours of treatment, the insertion material (carbon) is completely detached. The copper is free of particles, shows no signs of corrosion on the surface and the active material is in the form of small intact particles (FIG. 4).

### Example 5: Detaching a Negative Electrode in an Ethaline Ionic Liquid Medium with Ultrasound Activation According to the Invention

A SAMSUNG 18650 Li-ion battery is first discharged, opened and then dried. The negative electrode (carbon and copper collector) is removed manually. Electrode pellets are then immersed in 50 ml of an ethaline ionic liquid solution (choline chloride: ethylene glycol mixture in a ratio of 1:2) at 30° C. under stirring at 200 rpm and in the presence of ultrasounds.

After 3 minutes of treatment, the insertion material (carbon) is completely detached. The copper is free of particles and without corrosion on the surface, while the carbon is in the form of small intact particles (FIG. 5).

### Example 6: Detaching a Negative Electrode in an Ethaline Ionic Liquid Medium with Ultrasound Activation According to the Invention

A SONY 18650 Li-ion battery is first discharged, opened and then dried. The negative electrode (carbon and copper collector) is removed manually. Electrode pellets are then immersed in 50 ml of an Ethaline ionic liquid solution (choline chloride:ethylene glycol mixture in a ratio of 1:2) at 30° C. under stirring at 200 rpm and in the presence of ultrasounds.

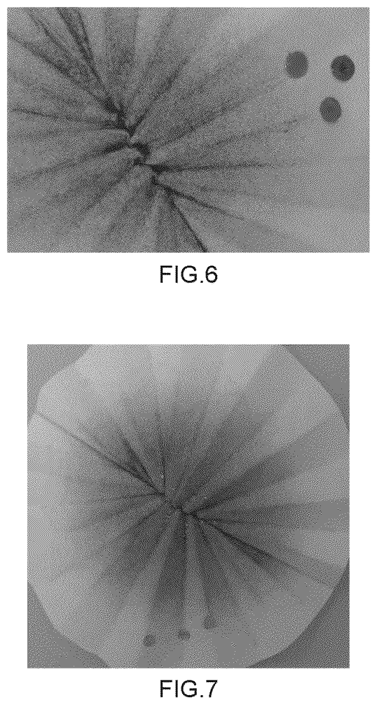

After 30 minutes of treatment, the insertion material (carbon) is completely detached. The copper is free of particles and without corrosion on the surface, while the carbon is in the form of small intact particles (FIG. 6).

### Example 7: Detaching a Positive Electrode in an Ethaline Ionic Liquid Medium with Ultrasound Activation According to the Invention

A SAMSUNG 18650 Li-ion battery is first discharged, opened and then dried. The positive electrode (NMC and aluminium collector) is removed manually. Electrode pellets are then immersed in 50 ml of an Ethaline ionic liquid solution (choline chloride: ethylene glycol mixture in a ratio of 1:2) at 120° C. under stirring at 200 rpm and in the presence of ultrasounds.

After only 10 minutes of treatment, the active material is completely detached. The aluminium is free of particles and without corrosion on the surface, while the active material (Li(NiMnCo)_{1/3}O₂)) is in the form of small intact particles (FIG. 7).

### REFERENCES

[1] Zeng et al. “Innovative application of ionic liquid to separate Al and cathode materials from spent high-power lithium-ion batteries”, Journal of Hazardous Materials (2014) 271, 50-56.
[2] Wang et al. “Efficient Separation of Aluminum Foil and Cathode Materials from Spent Lithium-Ion Batteries Using a Low-Temperature Molten Salt”, ACS Sustainable Chemistry & Engineering (2019), 7(9), 8287-8294.
[3] Wang et al. “A low-toxicity and high-efficiency deep eutectic solvent for the separation of aluminum foil and cathode materials from spent lithium-ion batteries” Journal of Hazardous Materials (2019), 380, 120846.

What is claimed is:

1.-12. (canceled)

13. A method for recycling at least one electrode comprising the following successive steps:
a) providing at least one electrode comprising a current collector and an active material,
b) immersing the at least one electrode in an ionic liquid solution, comprising a solvent ionic liquid, in the presence of ultrasounds, whereby the active material is separated from the current collector.

14. A method according to claim 13, wherein the at least one electrode further comprises a binder and wherein, during step b), the binder is separated from the current collector.

15. The method according to claim 13, wherein the solvent ionic liquid comprises a cation selected from one of the following families: imidazolium, pyrrolidinium, ammonium, piperidinium and phosphonium.

16. The method according to claim 15, wherein the cation is an ammonium or phosphonium cation, and further comprising a chloride anion.

17. The method according to claim 13, wherein the solvent ionic liquid comprises an anion selected from halides, bis(trifluoromethanesulphonyl)imide (CF₃SO₂)₂N⁻, bis(fluorosulphonyl)imide (FSO₂)₂N⁻, trifluoromethanesulphonate, tris(pentafluoroethyl)trifluorophosphate and bis(oxalato)borate anions.

18. The method according to claim 17, wherein the anion is a chloride, and further comprising an ammonium or phosphonium cation.

19. The method according to claim 18, wherein the solvent ionic liquid is [P66614][CI].

20. The method according to claim 13, wherein the ionic liquid solution forms a deep eutectic solvent.

21. The method according to claim 20, wherein the deep eutectic solvent is a mixture of choline chloride and ethylene glycol.

22. The method according to claim 13, wherein step b) is carried out at a temperature ranging from 20° ° C. to 150° C.

23. The method according to claim 22, wherein step b) is carried out at a temperature ranging from 30° ° C. to 120° C.

24. The method according to claim 13, wherein step b) is carried out for a duration ranging from 2 min to 1 h.

25. The method according to claim 24, wherein step b) is carried out for a duration ranging from 3 min to 30 min.

26. The method according to claim 13, wherein the power of the ultrasounds ranges from 0.5 to 16 kW.

27. The method according to claim 26, wherein the frequency of the ultrasounds is between 16 KHz and 500 KHz.

28. The method according to claim 27, wherein the frequency of the ultrasounds is between 16 KHz and 50 KHz.

29. The method according to claim 13, wherein the ionic liquid solution further comprises one or more additional ionic liquids.

30. The method according to claim 13, wherein in step a) a plurality of electrodes is provided, said electrodes being identical or of different natures.
